(19) United States
(12) Patent Application Publication
(10) Pub. No.: US 2017/0011769 A1
(43) Pub. Date: Jan. 12, 2017

(54) MAGNETIC DISK DEVICE AND METHOD OF CONTROLLING MAGNETIC DISK DEVICE

(71) Applicant: Kabushiki Kaisha Toshiba, Tokyo (JP)

(72) Inventors: Jun Shang, Fujisawa Kanagawa (JP); Shoichi Aoki, Yokohama Kanagawa (JP)

(21) Appl. No.: 14/978,708

(22) Filed: Dec. 22, 2015

(30) Foreign Application Priority Data
Jul. 6, 2015 (JP) 2015-135410

(51) Int. Cl. G11B 20/12; G11B 20/18

(52) U.S. Cl. CPC G11B 20/1217; G11B 20/1816; G11B 2020/1292; G11B 2020/1238

(57) ABSTRACT

According to one embodiment, first data is written into a first storage area with a shingled write recording scheme. A verification process is performed. The verification process includes reading second data and checking whether or not a read error has occurred. The second data is partial data of the first data written into the first storage area and is data written into a sector of the first track that is adjacent to a sector of the second track for which writing has completed.

### CROSS-REFERENCE TO RELATED APPLICATIONS

This application is based upon and claims the benefit of priority from Japanese Patent Application No. 2015-135410, filed on Jul. 6, 2015; the entire contents of which are incorporated herein by reference.

### FIELD

Embodiments described herein relate generally to a magnetic disk device and a method of controlling a magnetic disk device.

### BACKGROUND

In the field of magnetic disk devices, in order to implement a high density of a magnetic disk, shingled write recording has been proposed. The shingled write recording is a recording technology in which track pitches are shortened and data is recorded in such a manner that shingles are arranged such that a part of adjacent tracks overlaps each other. A magnetic disk may include a shingled write recording area for which shingled write recording is performed and a non-shingled write recording area for which normal magnetic recording is performed with a recording width corresponding to a write track width.

Such a magnetic disk device may perform a read verification process so as to verify write data at high temperature or low temperature. In a magnetic disk device of which a recording area is managed by the drive itself, after write data is written into a non-shingled write recording area, the written data is read and verified, and, after the temperature is returned to a normal temperature, the data written into the non-shingled write recording area is written into the shingled write recording area. On the other hand, for a magnetic disk device of which the recording area is managed by a host, a specification is defined in which data is directly written into the shingled write recording area in response to a write request from the host. In order to comply with this specification, at high temperature or low temperature, the read verification process needs to be performed for the shingled write recording area.

### BRIEF DESCRIPTION OF THE DRAWINGS

FIG. 1 is a functional block diagram that illustrates an internal configuration of a magnetic disk device;

FIG. 2 is a block diagram that illustrates an example of a functional configuration of a controller;

FIG. 3 is a diagram that illustrates recording areas of a magnetic disk;

FIG. 4 is a diagram that illustrates a relation between tracks and zones in a shingled write recording area;

FIG. 5 is a diagram for explaining a state in which a shingled-state is not confirmed;

FIG. 6 is a flowchart that illustrates a processing sequence performed when a write request is received from a host; and

FIG. 7 is a flowchart that illustrates an example of a sequence of a verification process for a shingled write recording area.

### DETAILED DESCRIPTION

In general, according to one embodiment, a magnetic disk device includes a magnetic head, a magnetic disk, and a controller. The magnetic disk includes a first storage area for which recording is performed with a first recording scheme by the magnetic head. The first recording scheme includes repetitive overlapping of a part of a second track with a first track. The second track is adjacent to the first track. The controller writes first data into the first storage area with the first recording scheme. The controller performs a verification process. The verification process includes reading second data and checking whether or not a read error has occurred, The second data is partial data of the first data written into the first storage area and is data written into a sector of the first track that is adjacent to a sector of the second track for which writing has completed.

Exemplary embodiments of a magnetic disk device and a method of controlling a magnetic disk device will be described below in detail with reference to accompanying drawings. The present invention is not limited to the following embodiments.

### Embodiment

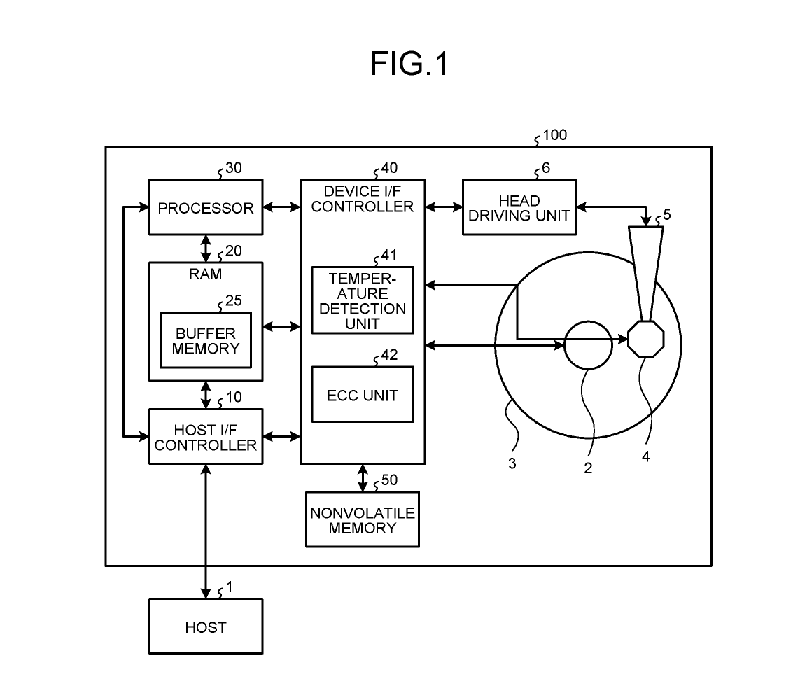

FIG. 1 illustrates an example of the configuration of a magnetic disk device 100 according to an embodiment. The magnetic disk device 100 known as a hard disk drive (HDD) is connected to a host apparatus (hereinafter, abbreviated as a host) 1 and functions as an external storage device of the host 1.

The magnetic disk device 100 includes a magnetic disk 3 that is a recording medium rotated by a spindle motor 2. The magnetic disk device 100 includes a head actuator 5 that is driven by a head driving unit 6. At a tip end of the head actuator 5, a magnetic head 4 used for writing and reading data is mounted.

The magnetic disk device 100 includes: a host interface controller (host I/F controller) 10; a random access memory (RAM) 20; a processor 30; a device interface controller (device I/F controller) 40; and a nonvolatile memory 50 as a control system.

The host I/F controller 10 communicates with the host 1 for a command, data, a status report, and the like. When a command is received from the host 1, the host I/F controller 10 notifies the processor 30 of the command. Under the control of the processor 30, the host I/F controller 10 buffers data received from the host 1 in a buffer memory 25 (RAM 20) or transmits data buffered in the buffer memory 25 to the host 1.

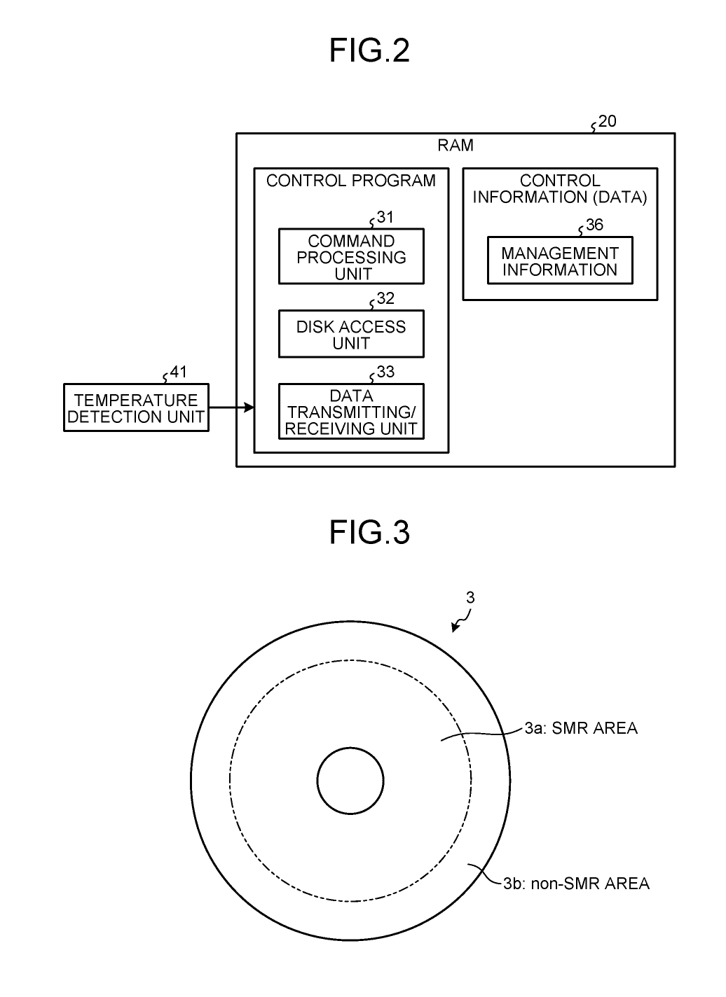

The RAM 20 has a storage area as the buffer memory 25 for temporarily storing data before write data supplied from the host 1 is written into the magnetic disk 3. In addition, the buffer memory 25 temporarily stores data before data read from the magnetic disk 3 is transmitted to the host 1. The RAM 20 further has a storage area for storing management information 36 (see FIG. 2) for managing data. In addition, firmware or the management information stored in the nonvolatile memory 50 or the magnetic disk 3 are loaded into the RAM 20. The management information managed in the RAM 20 is backed up in the nonvolatile memory 50 or the magnetic disk 3. As the RAM 20, a static random access memory (SRAM) or a dynamic random access memory (DRAM) is used.

The nonvolatile memory 50 is a nonvolatile semiconductor memory configured by a flash memory, an EEPROM, a NAND memory, or the like, and the firmware and the management information performed by the processor 30 are stored therein.

By controlling the driving of the spindle motor 2, the magnetic head 4, and the head driving unit 6, the device I/F controller 40 writes data into the magnetic disk 3 and reads data from the magnetic disk 3. The device I/F controller 40 includes a temperature detection unit 41 and an ECC unit 42. The temperature detection unit 41 measures ambient temperature of the magnetic disk device 100. The temperature detection unit 41 notifies the processor 30 of the detected ambient temperature. The ECC unit 42 is used for a verification process of data read from the magnetic disk 3. The ECC unit 42 executes an error correction coding process for data transmitted from the buffer memory 25, thereby generating parities. In addition, the ECC unit 42 executes an error correction decoding process by using data and parities read from the magnetic disk 3.

The processor 30 realizes various functions by using the firmware stored in the nonvolatile memory 50. When the magnetic disk device 100 starts to be operated, the firmware stored in the nonvolatile memory 50 is loaded into the RAM 20. The processor 30 executes the firmware loaded in the RAM 20. A function executed by the processor 30 will be described later.

When a write command and write data supplied from the host 1 are received by the host I/F controller 10, the processor 30 analyzes the content of the write command and stores the write data into the buffer memory 25. Thereafter, the write data is read from the buffer memory 25 and is input to the device I/F controller 40. The device I/F controller 40 codes the input write data and drives a writing element of the magnetic head 4, thereby writing the coded write data to the magnetic disk 3. When the coded write data is written, the device I/F controller 40 writes the data into a target track specified by the command with controlling the driving of the head driving unit 6 and the spindle motor 2.

On the other hand, when a read command supplied from the host 1 is received by the host I/F controller 10, the processor 30 analyzes the read command. Thereafter, the processor 30 instructs the device I/F controller 40 based on a result of the analysis. As a result, the magnetic head 4 is driven by the device I/F controller 40, and a signal is read by a reading element of the magnetic head 4. The read signal is demodulated by the device I/F controller 40 as read data. In addition, after being decoded, the read data is buffered into the buffer memory 25. Thereafter, the read data is transmitted to the host 1 by the host I/F controller 10.

FIG. 2 is a block diagram that illustrates an example of the functional configuration of firmware (control program) loaded into the RAM 20. The control program includes: a command processing unit 31; a disk access unit 32; and a data transmitting/receiving unit 33 and functions as a part of a controller of the magnetic disk device 100. The control information (control data) is used by the control program. As the control information, here, the management information 36 is illustrated. The command processing unit 31 analyzes a command received from the host 1 and notifies the disk access unit 32 and the data transmitting/receiving unit 33 of a result of the analysis. By controlling the device I/F controller 40 based on the result of the analysis of the command, the disk access unit 32 drives the spindle motor 2, the magnetic head 4, and the head driving unit 6, thereby executing a read/write operation for the magnetic disk 3. The disk access unit 32 executes the process of updating the management information 36 in accompaniment with a write operation for the magnetic disk 3. By controlling the host I/F controller 10 and the device I/F controller 40, the data transmitting/receiving unit 33 controls transmission of data between the magnetic disk 3 and the host 1 through the buffer memory 25. The ambient temperature detected by the temperature detection unit 41 is input to the control program.

FIG. 3 is a diagram that illustrates recording areas of the magnetic disk 3. The magnetic disk 3 includes an SMR area 3a for which shingled write recording is performed and a non-SMR area 3b for which normal magnetic recording is performed with a width corresponding to a writing element width. The SMR area 3a has a capacity corresponding to a user capacity that can be freely used by a user. The non-SMR area 3b is secured as a surplus inside the magnetic disk 3 in addition to the user capacity. The non-SMR area 3b is used as an area for caching data written into the SMR area 3a (media cache area). Commonly, the SMR area 3a is assigned to an inner area, and the non-SMR area 3b is assigned to an outer area. However, it may be configured such that the SMR area 3a is assigned to the outer side, and the non-SMR area 3b is assigned to the inner side.

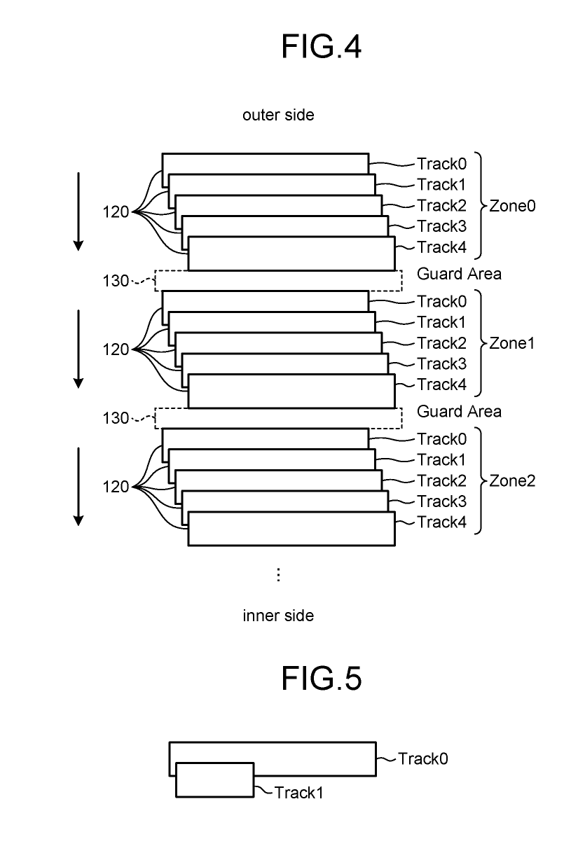

FIG. 4 illustrates a relation between tracks and zones in which data is recorded in a shingled write recording manner in the SMR area 3a. The SMR area 3a includes a plurality of zones according to a radial position of the magnetic disk 3. In FIG. 4, for the simplification of drawing, three zones (Zone 0 to Zone 2) are illustrated. Each zone includes a plurality of tracks. In FIG. 4, for the simplification of drawing, a case is illustrated in which one zone includes five tracks 120 (Track 0 to Track 4). Each frame represents a track 120 for which a write operation is completed. In each zone, as represented by arrows, shingled write recording is performed from the outer side to the inner side in order of Track 0, Track 1, Track 2, . . . Between zones, a guard area 130 is arranged. This guard area 130 is an area in which data is not written. In each zone, shingled write recording may be performed from the inner side to the outer side.

In the magnetic disk device 100, at high temperature or low temperature, in order to verify write data requested to be written from the host 1, a verification process is performed. In the verification process, in order to check whether written data is readable, the following process is performed. The data written into the magnetic disk 3 is read, and the read data is decoded by the ECC unit 42. As a result of the decoding process, in a case where a read error does not occur, in other words, in a case where the decoding process is successful, the verification process is determined to be successful. On the other hand, in a case where a read error occurs, and the verification process is not successful, a parameter relating to the read process is changed, and data is read from the magnetic disk 3 again and is decoded. In this decoding process, in a case where a read error does not occur, the verification process is determined to be successful. On the other hand, in a case where a read error occurs, the verification process is determined to be not successful. A series of processes including the read process and the decoding process can be performed up to a certain upper limit number of times.

For the non-SMR area 3b, the verification process described above can be directly applied. However, in a case where the verification process described above is directly applied to the SMR area 3a, there is a possibility that the verification is performed for a track of which a shingled-state has not been confirmed. A track of which the shingled-state is confirmed, like each track illustrated in FIG. 4, is a track for which a write process for all the sectors of an adjacent track for which a subsequent write process is performed has been completed. In FIG. 4, in a case where Track 0 of Zone 0 is focused on, a write process for Track 1, which is an adjacent track for which a subsequent write process is performed, of Zone 0 has been completed. FIG. 5 illustrates a track of which the shingled-state has not been confirmed. In FIG. 5, a write process for Track 1 that is an adjacent track of Track 0 has been completed up to a sector disposed in the middle of track 1. In FIG. 5, in this state, when the verification process is performed for Track 0, a read area of Track 0 at the time of execution of the verification is narrowed by a write operation for the subsequent Track 1, and thus, data of Track 0 cannot be guaranteed although the verification has been performed.

For this reason, in a magnetic disk device of which the recording area is managed by the drive itself, in order to perform the verification process at high temperature or low temperature, the following process is performed. In a magnetic disk device of which the recording area is managed by the drive itself, the drive initiatively performs the shingled write recording control. At high temperature or low temperature, write data is written into the non-SMR area 3b, and the verification process described above is performed for the written data. After the temperature is returned to a normal temperature, the data written into the non-SMR area 3b is written into the SMR area 3a. In this technique, all the write data is written into the non-SMR area 3b, and there is a possibility of a decrease in the performance due to insufficient capacity of the non-SMR area 3b. The magnetic disk device of which the recording area is managed by the drive itself may be referred to as a drive manage-type magnetic disk device.

On the other hand, for a magnetic disk device of which the recording area is managed by a host, a specification is defined in which data is directly written into the SMR area 3a in response to a write request from the host. In the magnetic disk device of which the recording area is managed by the host, the host initiatively performs the shingled write recording control. In order to comply with this specification, at a high temperature or low temperature, the verification process needs to be performed for the SMR area 3a. The magnetic disk device of which the recording area is managed by the host may be referred to as a host aware/host manage-type magnetic disk device.

Thus, in this embodiment, in a high-temperature environment or a low-temperature environment, a technique for realizing a verification process while securing the data reliability of a shingled write recording area is proposed. In this embodiment, a verification process is performed for data that is a part of data written into the SMR area 3a and is data of which the shingled-state is confirmed. In other words, in the SMR area 3a, repetitive overlapping of a part of a second track with a first track is performed. The part of the second track is a track adjacent to the first track. In the embodiment, a verification process is performed. The verification process includes reading second data and checking whether or not a read error has occurred. The second data is partial data of first data written into the SMR area 3a and is data written into a sector of the first track that is adjacent to a sector of the second track for which writing has completed.

In addition, in the embodiment, when a write request is received from the host 1, in the case of a high-temperature environment or a low-temperature environment, first, write data is written into the non-SMR area 3b, and the verification process described above is performed for the written data. Next, the write data is written into the SMR area 3a. Then, the verification process described above is performed for data of which the shingled-state is confirmed among the data written into the SMR area 3a. For a data range for which the verification process is successful, the data of the non-SMR area 3b is set to be invalid, and the data of the SMR area 3a is set to be valid. In addition, for a data range for which the verification process is not successful, the data of the non-SMR area 3b is set to be valid, and the data of the SMR area 3a is set to be invalid.

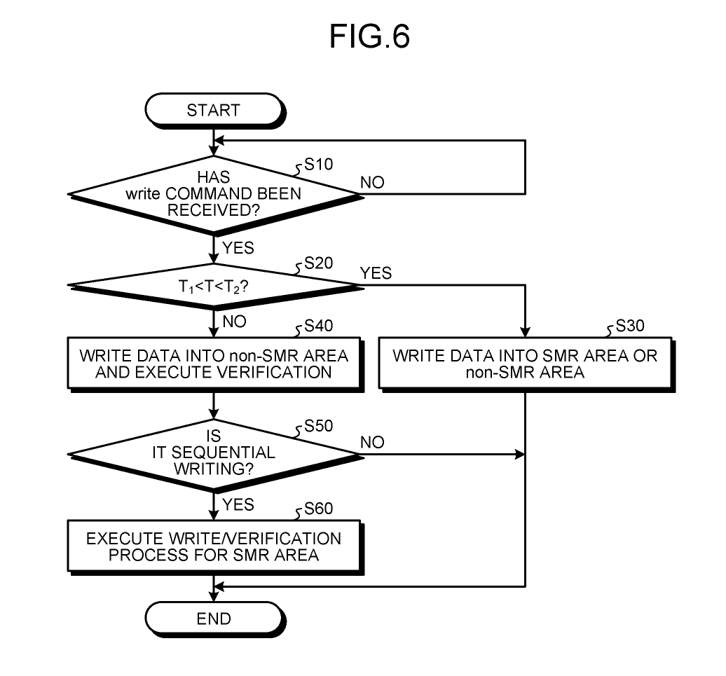

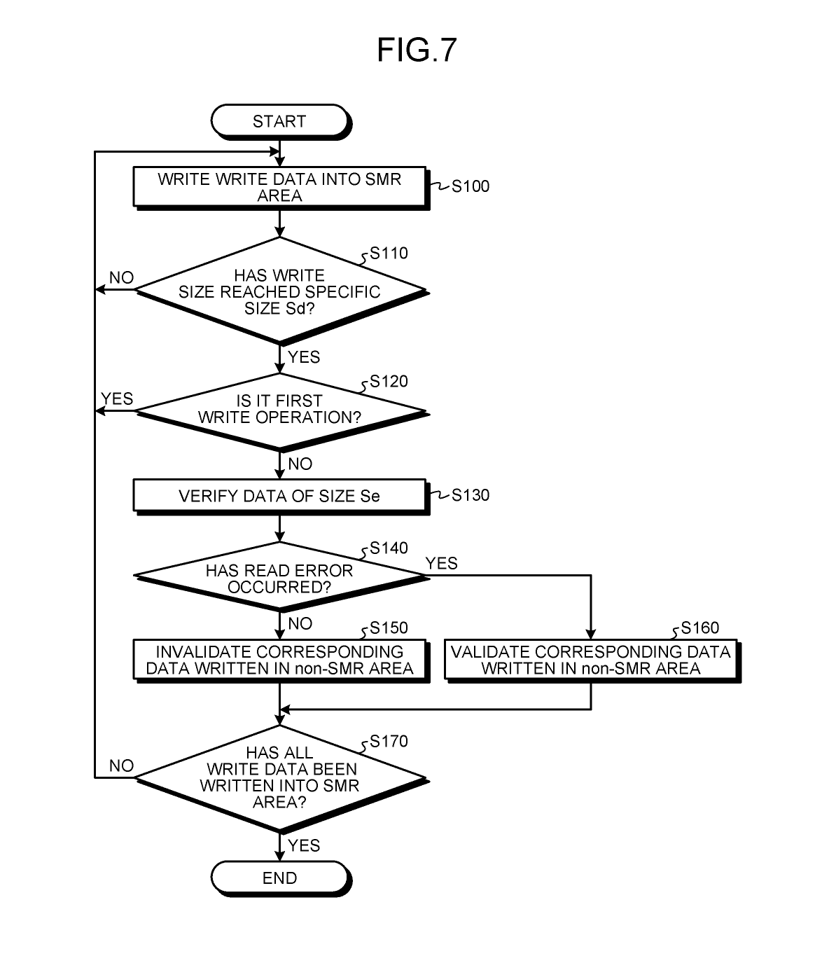

Hereinafter, an operation performed when a write request is received from the host 1 will be described along flowcharts illustrated in FIGS. 6 and 7. FIG. 6 is a flowchart that illustrates the processing sequence performed when a write request is received from the host. FIG. 7 is a flowchart that illustrates an example of the detailed sequence of a write/verification process for the SMR area 3a.

In the magnetic disk device of which the recording area is managed by the host, one zone is defined to have a fixed size (for example, 256 MiB), and one zone is configured by about 100 to 200 tracks. In addition, in each zone, a relation between a logical address specified by the host 1 and a physical address of the magnetic disk 3 is fixed. The logical address, for example, is a logical block addressing (LBA). In addition, in each zone, there is a restriction that sequential write is performed.

When a write command is received by the host I/F controller 10, the processor 30 analyzes the content of the write command and stores write data into the buffer memory 25 (S10). The processor 30 obtains a detected temperature T from the temperature detection unit 41 and determines whether or not the detected temperature T is within a range between a lower limit value T1 and an upper limit value T2 (S20). In a case where the detected temperature T is within the range between the lower limit value T1 and the upper limit value T2 (S20: Yes), the processor 30 performs a write process with a normal scheme. In the normal scheme, the write data stored in the buffer memory 25 is written into the non-SMR area 3b or the SMR area 3a of the magnetic disk 3 through the device I/F controller 40 (S30). In the case of the normal scheme, the verification process is not performed.

On the other hand, in a case where the detected temperature T is not within the range between the lower limit value T1 and the upper limit value T2 (S20: No), the processor 30 performs a write process in a high/low-temperature mode. In the write process in the high/low-temperature mode, the verification process is performed. First, the processor 30 writes the write data stored in the buffer memory 25 into the non-SMR area 3b of the magnetic disk 3 through the device I/F controller 40. In addition, the processor 30 performs the verification process including the read process and the decoding process described above for the data written into the non-SMR area 3b (S40).

Next, the processor 30 determines whether or not the received write command represents sequential writing (S50). In a case where identification information used for identifying sequential writing or random writing is included in the write command, the processor 30 performs a determination of S50 based on the identification information. On the other hand, in a case where the identification information is not included in the write command, the processor 30 performs the determination of S50 by determining the continuity of logical addresses (LBA) included in several write commands.

In a case where the received write command represents not the sequential writing but the random writing (S50: No), the processor 30 ends the process.

On the other hand, in a case where the received write command represents the sequential writing (S50: Yes), the processor 30 performs write/verification process for the SMR area 3a (S60).

Next, an example of the write/verification process for the SMR area 3a will be described in detail with reference to FIG. 7. When the determination of S50 illustrated in FIG. 6 is Yes, the processor 30 writes the write data stored in the buffer memory 25 into the SMR area 3a of the magnetic disk 3 through the device I/F controller 40 (S100). In other words, the processor 30 reads data that is the same as the data written into the non-SMR area 3b from the buffer memory 25 and writes the read data into the SMR area 3a. In addition, in S100, in a case where the same data as the data written into the non-SMR area 3b is not present in the buffer memory 25, it may be configured such that the data written in the non-SMR area 3b is read, and the read data is written into the SMR area 3a.

Next, the processor 30 determines whether or not the size of data written into the SMR area 3a reaches a specific size Sd (S110). For example, the size Sd has a value corresponding to a plurality of tracks. In a case where the data size does not reach the specific size Sd (S110: No), the processor 30 writes data into the SMR area 3a until the data size reaches the specific size Sd (S100).

When the data size reaches the specific size Sd (S110: Yes), the processor 30 determines whether or not this write operation is a first write operation in units of the size Sd for the SMR area 3a (S120). In the case of the first write operation (S120: Yes), for all of the data corresponding to the size Sd from a first sector for which the write operation is started, the shingled-state has not been confirmed, therefore the process proceeds to S100. The processor 30 further writes the write data stored in the buffer memory 25 into the SMR area 3a of the magnetic disk 3 through the device I/F controller 40 (S100).

When the data size reaches the specific size Sd again according to the write operation (S110: Yes), the processor 30 performs the determination of S120 again. This is a second write operation in units of the size Sd, the determination of S120 is No. In this step, data of which the data size is 2Sd is written in the SMR area 3a. The processor 30 sets data of a size Se from first sector data among the data of the size 2Sd as a target for the verification process described above. The size Se is determined in consideration of the number of tracks (or the number of sectors) of which the shingled-state is confirmed when the write size for the SMR area 3a reaches the specific size Sd and the influence of an adjacent track interference (ATI). It may be set such that size Se<size Sd, or size Se=size Sd.

The processor 30 verifies data of a target for this verification (S130). In other words, the processor 30 reads data of a verification target from the SMR area 3a, decodes the read data by using the ECC unit 42, and determines whether or not a read error has occurred (S140). As a result of the decoding process, in a case where a read error has not occurred, the processor 30 determines that the verification process is successful. On the other hand, in a case where a read error has occurred, the processor 30 repeatedly performs a series of processes including the read process and the decoding process described above until the number of times of processing reaches at the upper limit number of times and determines that the verification process is successful in a case where the decoding process is successful until the number of times of processing reaches at the upper limit number of times. On the other hand, in a case where the decoding process is not successful until the number of times of processing reaches the upper limit number of times, the processor 30 determines that the verification process is not successful.

In a case where the verification process is successful (S140: No), the processor 30 invalidates corresponding data having the same logical address as that of data (data of which the shingled-state is confirmed) that is read this time from SMR area 3a as a verification target among the data written in the non-SMR area 3b (S150). In addition, the processor 30 validates data (data of which the shingled-state is confirmed) that is read this time from SMR area 3a as a verification target among data written in the SMR area 3a. The processor 30 validates or invalidates the data written in the non-SMR area 3b and the SMR area 3a by using the management information 36 managed in the RAM 20.

On the other hand, in a case where the verification process is not successful (S140: Yes), the processor 30 validates corresponding data having the same logical address as that of data (data of which the shingled-state is confirmed) that is read this time from SMR area 3a as a verification target among the data written in the non-SMR area 3b (S160). Accordingly, the data of the area in which the verification error has occurred among the data written in the SMR area 3a is protected in the non-SMR area 3b. In addition, the processor 30 invalidates data (data of which the shingled-state is confirmed) that is read this time from SMR area 3a as a verification target among the data written in the SMR area 3a.

The processor 30 determines whether or not all of the write data requested by the write command has been written in the SMR area 3a (S170). In a case where the determination is Yes, the process ends. On the other hand, in a case where the determination is No, the process proceeds to S100.

When the process proceeds to S100, the processor 30 further writes the write data stored in the buffer memory 25 into the SMR area 3a of the magnetic disk 3 through the device I/F controller 40. When the data size reaches the specific size Sd again according to this write operation (S110: Yes), the processor 30 performs the determination of S120. This is the third write operation, and the determination of S120 is No. In this step, data of a data size 3Sd is written in the SMR area 3a. The processor 30 sets data of a size Se from a first sector data among data of a size (3Sd−Se) for which the verification process has not been performed as a target for the next verification (S130).

Until all the data specified by the write command is written into the SMR area 3a, the same process is repeatedly performed.

For example, Sd=4000h. When data of 4000h is written into the SMR area 3a (S100), the determination of S110 becomes Yes. In the case of the first write operation, the determination of S120 is Yes, and data is further written into the SMR area 3a. When the data size exceeds the Sd again according to this write operation, the determination of S110 is Yes. In this step, data of a total of 8000h is written in the SMR area 3a.

Here, it is assumed that Se=4000h. In S130, data of the size Se (4000h) from the first sector data among the data of a total of 8000h written into the SMR area 3a is set as a target for the verification process. In a case where this verification process is successful, the process of S150 is performed. On the other hand, in a case where this verification process is not successful, the process of S160 is performed.

In a case where data that has not been written into the SMR area 3a is present, data is further written into the SMR area 3a (S100). When the data size exceeds the Sd again according to this write operation, the determination of S110 becomes Yes. In this step, data of a total of C000h is written in the SMR area 3a.

In S130, data of the size Se (4000h) from the 4001h-th sector data among the data written into the SMR area 3a is set as a target for the verification process. In a case where this verification process is successful, the process of S150 is performed. On the other hand, in a case where this verification process is not successful, the process of S160 is performed.

In this way, when all the data specified by the write command is written into the SMR area 3a, the write process ends.

As above, in this embodiment, when a write request is received from the host 1, in the case of a high-temperature environment or a low-temperature environment, the verification process is performed for a part of data of which the shingled-state is confirmed among the data written in the SMR area 3a. For this reason, according to this embodiment, a verification process having high accuracy can be efficiently performed for the SMR area 3a, and the data reliability of the SMR area 3a can be secured.

In addition, according to this embodiment, in the case of a high-temperature environment or a low-temperature environment, first, write data is written into the non-SMR area 3b, and the verification process is performed. Thereafter, the write data is written into the SMR area 3a, and the verification process is performed. Then, data of the non-SMR area 3b corresponding to the data of the SMR area 3a in which a read error has not occurred is invalidated. For this reason, the capacity insufficiency of the non-SMR area 3b can be suppressed.

In the embodiment described above, while the non-SMR area 3b is assigned to the magnetic disk 3, the non-SMR area 3b may be assigned to the nonvolatile memory 50. Furthermore, the non-SMR area 3b may be assigned to a nonvolatile storage unit different from the nonvolatile memory 50.

In addition, according to the embodiment described above, in a low-temperature environment or a high-temperature environment, while the verification process as illustrated in FIGS. 6 and 7 is performed, it may be configured such that a vibration detection unit detecting a vibration of the magnetic disk device is arranged, and the verification process illustrated in FIGS. 6 and 7 may be performed when the detected vibration exceeds a certain upper limit value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic head;
a magnetic disk that includes a first storage area for which recording is performed with a first recording scheme by the magnetic head, the first recording scheme including repetitive overlapping of a part of a second track with a first track, the second track being adjacent to the first track; and
a controller configured to:
write first data into the first storage area with the first recording scheme; and
perform a verification process, the verification process including reading second data and checking whether or not a read error has occurred, the second data being partial data of the first data written into the first storage area and being data written into a sector of the first track that is adjacent to a sector of the second track for which writing has completed.

2. The magnetic disk device according to claim 1, wherein the controller performs the verification process after a size of the first data written in the first storage area reaches a first size.

3. The magnetic disk device according to claim 2, wherein the second data has a second size smaller than the first size.

4. The magnetic disk device according to claim 3, wherein the second size is determined based on the number of third tracks at a time when the size of the first data written in the first storage area reaches the first size and an influence of an adjacent track interference, the third tracks being the first tracks and to which a write process for all sectors of the second track that is adjacent has been completed.

5. The magnetic disk device according to claim 1, further comprising a second storage area for which recording is performed with a second recording scheme different from the first recording scheme, and wherein
the controller is configured to:
in a case where a first condition is satisfied, write the first data before being written into the first storage area into the second storage area with the second recording scheme and perform the verification process including reading third data that is the first data written into the second storage area; and
in a case where the read error has not occurred in the verification process, invalidate fourth data, the fourth data being data among the third data and corresponding to the second data.

6. The magnetic disk device according to claim 5, wherein, in a case where the read error has occurred in the verification process, the controller is configured to validate the fourth data.

7. The magnetic disk device according to claim 5, further comprising a temperature detection unit,
wherein the controller determines that the first condition is satisfied when a detected temperature obtained by the temperature detection unit exceeds an upper limit value, or when the detected temperature is below a lower limit value.

8. The magnetic disk device according to claim 5, further comprising a vibration detection unit,
wherein the controller determines that the first condition is satisfied when a detected vibration obtained by the vibration detection unit exceeds an upper limit value.

9. The magnetic disk device according to claim 5, wherein the magnetic disk includes the second storage area.

10. The magnetic disk device according to claim 5, further comprising a nonvolatile memory including the second storage area.

11. A method of controlling a magnetic disk device including a magnetic disk that includes a first storage area for which recording is performed with a first recording scheme, the first recording scheme including repetitive overlapping of a part of a second track with a first track, the second track being adjacent to the first track, the method comprising:
writing first data into the first storage area with the first recording scheme; and
performing a verification process, the verification process including reading second data and checking whether or not a read error has occurred, the second data being partial data of the first data written into the first storage area and being data written into a sector of the first track that is adjacent to a sector of the second track for which writing has completed.

12. The method according to claim 11, wherein the verification process is performed after a size of the first data written in the first storage area reaches a first size.

13. The method according to claim 12, wherein the second data has a second size smaller than the first size.

14. The method according to claim 13, wherein the second size is determined based on the number of third tracks at a time when the size of the first data written in the first storage area reaches the first size and an influence of an adjacent track interference, the third tracks being the first tracks and to which a write process for all sectors of the second track that is adjacent has been completed.

15. The method according to claim 11, wherein the magnetic disk device further includes a second storage area for which recording is performed with a second recording scheme different from the first recording scheme, the method further comprising:
in a case where a first condition is satisfied, writing the first data before being written into the first storage area into the second storage area with the second recording scheme and performing the verification process including reading third data that is the first data written into the second storage area; and
in a case where the read error has not occurred in the verification process, invalidating fourth data, the fourth data being data among the third data and corresponding to the second data.

16. The method according to claim 15, further comprising validating the fourth data in a case where the read error has occurred in the verification process.

17. The method according to claim 15,
wherein the magnetic disk device further includes a temperature detection unit, and
wherein the case where the first condition is satisfied is a case where a detected temperature obtained by the temperature detection unit exceeds an upper limit value or a case where the detected temperature is below a lower limit value.

18. The method according to claim 15,
wherein the magnetic disk device further includes a vibration detection unit, and
wherein the case where the first condition is satisfied is a case where a detected vibration obtained by the vibration detection unit exceeds an upper limit value.

19. The method according to claim 15, wherein the magnetic disk includes the second storage area.

20. The method according to claim 15, wherein the magnetic disk device further includes a nonvolatile memory including the second storage area.
